(19) United States
(12) Patent Application Publication
(10) Pub. No.: US 2026/0216654 A1
(43) Pub. Date: Jul. 30, 2026

(54) INTEGRATED PRE-FILTER FOR UF/MF MEMBRANE SYSTEM

(71) Applicant: DUPONT SAFETY & CONSTRUCTION, INC, Wilmington, DE (US)

(72) Inventors: Michael HOFFMANN, Greifenberg (DE); Christian STAAKS, Greifenberg (DE); Martin HEIJNEN, Greifenberg (DE); Michael KASSEN, Greifenberg (DE); Dominik BOTSCHAFTER, Greifenberg (DE); Steven D. JONS, Edina, MN (US)

(21) Appl. No.: 19/143,003

(22) PCT Filed: Dec. 28, 2023
(86) PCT No.: PCT/US2023/086290

§ 371 Date: Jun. 25, 2025

Related U.S. Application Data
(60) Provisional application No. 63/477,616, filed on Dec. 29, 2022.

(51) Int. Cl. B01D 61/16; B01D 61/14; B01D 61/18; B01D 63/04; B01D 65/02; C02F 1/00; C02F 1/44

(52) U.S. Cl. CPC B01D 61/16; B01D 61/145; B01D 61/147; B01D 61/18; B01D 63/046; B01D 65/02; C02F 1/004; C02F 1/444; B01D 2311/04; B01D 2313/105; B01D 2313/21; B01D 2321/04; B01D 2321/16; C02F 2303/16

(57) ABSTRACT

A filtration element 1 comprises a filtration membrane 3 enclosed in a housing 2. The element has openings for removing filtrate and concentrate. A filter 11 is positioned within the element 1, at an opening 6 in the housing 2, for introducing feed into the interior volume 20 of the filtration element 11. Alternatively, the filter 11 may be positioned within an end cap 7 associated with such an opening. Accordingly, prefiltration takes place within the filtration element 1 itself, rather than in a separate upstream operation. The presence of the filter 11 does not produce a significant increase in pressure drop across the filtration module. Agglomerated particles and other debris that accumulate on the membrane can be removed easily by backwashing, despite the presence of the filter 11.

### FIELD OF THE INVENTION

Described herein are ultra- or microfiltration (UF/MF) modules and filtration systems employing them, particularly modules with an integrated pre-filter.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

Microfiltration and ultrafiltration systems are used in public utility and industrial settings to purify fluids or recover materials from fluid streams. The most important application is the purification of water, by treating process streams such as industrial waste, seawater, ground water, sewage and effluent from sewage treatment facilities. Other industrial uses include purifying and/or concentrating dairy products, fruit juices and other beverages; enzyme recovery; and dialysis.

Both microfiltration and ultrafiltration processes operate by passing a feed fluid through a porous membrane that retains high molecular weight and/or particulate matter. This produces a purified filtrate stream and a separate concentrate stream which contains the filtered materials. Microfiltration and ultrafiltration are generally distinguished by the sizes of the pores in the membrane. Microfiltration membranes are commonly used to remove particulate matter 0.1 to 2 micrometers in size. This is small enough to remove even larger microbial matter such as some bacteria. Ultrafiltration can remove matter as small as 0.005 micrometers, which is small enough that ultrafiltration processes can separate a wider range of microbes, including viruses and other pathogens, as well as macromolecules, nanoparticles, proteins, biological cell debris and so forth.

The membranes used for microfiltration and ultrafiltration on an industrial scale most often are hollow fiber membranes, although other types such as spiral membranes and tubular membranes can be used. The membranes are susceptible to fouling and damage from larger particles. For that reason, it is necessary to remove larger particles from the incoming feed fluid. In industrial and wastewater treatment settings, this is performed using a separate prefilter system upstream of the microfiltration/ultrafiltration system. For example, Chinese Pat. Appin. Publn. No. CN217312781 describes a sewage ultrafiltration device for environmental protection engineering. The device includes a two-piece shell, and a filter screen is installed on the inner wall of of one piece of the shell.

Large installations require significant numbers of microfiltration and ultrafiltration modules and corresponding numbers of separate prefilters. The prefilter system therefore occupies a large footprint and represents a large capital expense. The separate prefiltering system requires separate maintenance and operating systems, imposes a large additional operating cost and demands additional resources. The prefilter is typically a mesh or disc filter which often is not chemically cleaned. Water or other feed fluid losses are seen in the prefiltering operation. A large reduction in capital and operating costs could be obtained if the separate prefiltering system are smaller or even eliminated.

Clearly, there remains a need for improved pre-filtration apparatus, systems, and methods in microfiltration/ultrafiltration processes.

### SUMMARY OF THE INVENTION

Accordingly, provided herein is a filtration assembly 100 comprising a filtration element 1, said filtration element 1 comprising
a) a housing 2 enclosing an interior volume 20 of the filtration element 1;
b) at least one microfiltration or ultrafiltration membrane 3 disposed within the interior volume 20 of the housing 2;
c) at least one outlet 4 for removing filtrate from the filtration element 1;
d) at least one housing inlet 6 in the housing 2 for introducing feed fluid into the filtration element 1;
e) for at least one housing inlet 6, an associated inlet end cap 7 affixed to the housing 2 and in fluid communication with the housing inlet 6 in the housing 2, the inlet end cap 7 having an opening 8 for receiving feed fluid and defining a flow path for the feed fluid from the opening 8 of the inlet end cap 7 to the housing inlet 6 of the housing 2, and
f) for at least one housing inlet 6 having an associated inlet end cap 7, an associated filter 11 positioned (i) within the housing inlet 6 or (ii) within the associated inlet end cap 7 and within the flow path of the feed fluid from the opening of the inlet end cap 7 to the associated housing inlet 6 in the housing 2.

In some preferred embodiments, the nominal aperture size of the filter 11 is in the range of 5 to 500 μm. In other preferred embodiments, the feed fluid is in fluid communication with the housing inlet 6, and the associated filter 11 is positioned (i) within the housing inlet 6 or (ii) within the flow path of the feed fluid to the associated housing inlet 6 in the housing 2.

Further provided herein is filtration system 100 comprising:
a plurality of optionally cyclindrical filtration elements 1 arranged in parallel, each of said filtration elements 1 further comprising:
a housing 2 that encloses an interior volume 20;
a plurality of membranes 3 located within the interior volume 20; said membranes 3 selected from the group consisting of microfiltration, ultrafiltration, nanofiltration, and reverse osmosis membranes; and said membranes 3 dividing the interior volume 20 into a feed region and a filtrate region;
a housing inlet 6 for introducing a feed fluid into the feed region of the filtration element 1;
a housing outlet 4 for removing filtrate from the filtrate region of the filtration element 1; and
a feed fluid pipe 75 (referred to herein synonymously and interchangeably as “feed collecting header 75”) comprising a distribution conduit and a plurality of manifold or distributor outlets (the terms “manifold”, “header”, and “distributor” are synonymous and used interchangeably herein),
wherein each of said plurality of filtration elements 1 is associated with a specific manifold outlet, such that said plurality of membranes 3 within the filtration element 1 receive feed fluid from said specific manifold outlet; and at least one filter 11 is located along a feed flow pathway between the membranes 3 within the housing 2 of a filtration element 1 and the associated manifold outlet.

In this apparatus, preferably each filtration element 1 is associated with at least one filter 11, and said at least one filter 11 is located along a feed flow pathway between the membranes 3 within the housing 2 of that filtration element 1 and an associated manifold outlet. Preferably, the nominal size of the apertures in the filter 11 ranges from 5 to 500 μm.

The filtration element described herein offers several important advantages. Prefiltration takes place within the filtration element itself, rather than at some separate upstream operation. This allows the separate upstream prefiltering system to be reduced in size if not altogether eliminated, thereby reducing capital and operating costs substantially.

Surprisingly, the presence of the filter does not produce a significant increase in pressure drop across the filtration module, which includes the filter and associated parts designed for holding or mounting the filter within the filtration element. Therefore, operating pressures are not significantly impacted and pumping equipment does not need to be oversized to accommodate the filter.

Another advantage is that the agglomerated particles and other debris that accumulate on the membrane can be removed easily by backwashing, despite the presence of the filter. More specifically, it has now unexpectedly been found that agglomerated particles dislodged from the membrane 3 during backwashing easily break up under backwashing conditions to form small particles that pass readily back through the filter 11 and out of the filtration element 1. Debris is removed from the filter 11 during the backwashing process as well, allowing both the prefilter and the microfiltration or ultrafiltration membrane(s) 3 to be backwashed simultaneously. This allows for yet another reduction in operating costs. The integrated prefilter may be chemically cleaned simultaneously with routine membrane cleaning if desired, thus providing a process that does not require additional resources.

Further provided herein are a filtration assembly comprising at least one filtration element 1; a filtration system comprising an array of multiple filtration assemblies, preferably an array that includes at least one vertical row; and processes for filtering a feed fluid using the filter elements, assemblies, and systems described herein.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

FIG. 1 is a perspective view, partially in section, of a filtration assembly as described herein.

FIG. 2 is an enlarged front sectional view of a detail of a filtration assembly as described herein.

FIG. 3 is an enlarged perspective view, partially in section, of an inlet end cap attached to a housing, for use in a filtration assembly as described herein.

FIG. 4 is an end view of a filtration system comprising multiple filtration assemblies arranged in a row.

FIG. 5 is a perspective view of a filtration system comprising multiple filtration assemblies arranged in a row.

### DETAILED DESCRIPTION

As used herein, the term “feed fluid” refers to a fluid introduced into the filtration element for removal of impurities. The term “filtrate” (or “permeate”) refers to fluid that has passed through a discriminating layer of a microfiltration or ultrafiltration membrane within the filtration element and contains a lower concentration of impurities than feed fluid. The terms “reject” and “concentrate”, which are synonymous and used interchangeably herein, refer to that portion of the feed fluid that has not passed through (i.e., is rejected by) a discriminating layer of the microfiltration or ultrafiltration membrane and therefore contains a higher concentration of impurities than the feed fluid.

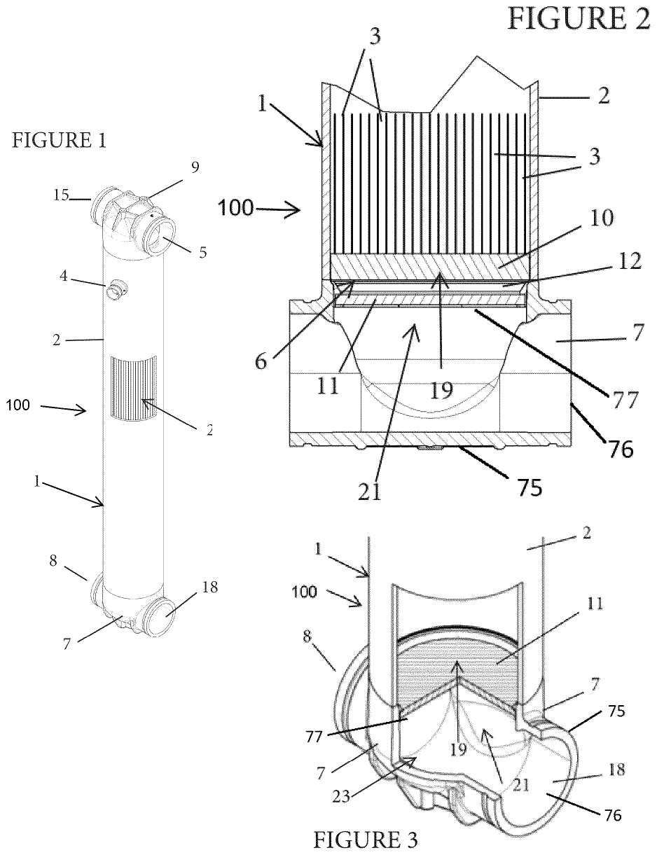

Referring now to the drawings, wherein like reference numerals designate corresponding structure throughout the views, and referring in particular to FIG. 1, filtration assembly 100 comprises filtration element 1, which in turn comprises housing 2, which encloses an interior volume (shown generally by reference numeral 20) of filtration element 1. Referring now to FIG. 2, microfiltration or ultrafiltration membranes 3 are disposed within interior volume 20 of housing 2. These membranes 3 may be embedded at each end in potting 10 or otherwise secured by other suitable means, These membranes 3 divide the interior volume 20 into a feed region and a filtrate region. The feed fluid becomes a filtrate upon passing through at least one of the membranes 3.

Still referring to FIG. 2, housing 2 comprises housing inlet 6 for introducing feed fluid into interior volume 20 of filtration element 1. The terms “inlet” and “outlet” are used generally herein to designate the direction of flow of the indicated fluid into and/or out of the filtration element 1 during normal operation, i.e., during the time when a feed fluid is being fed into the filtration element 1 for removal of impurities to produce a filtrate and a reject. Thus, in the particular embodiment shown in FIGS. 1-3, housing inlet 6 is an opening through which, during normal operation, feed fluid is introduced into housing 2; outlets 4 and 5 are openings through which, during normal operation, filtrate (via outlet 4) and concentrate (via outlet 5) are removed from filtration element 1. Fluids may flow in the opposite direction during other modes of operation, such as backwashing and/or cleaning. Thus, during backwashing and/or cleaning, fluids may be introduced into filtration element 1 through outlets 4 and/or 5, and may be withdrawn from housing 2 through housing inlet 6.

In the particular embodiment shown in FIGS. 1 and 2, the main direction of flow through filtration element 1 during normal operation is generally upward, with feed fluid being introduced into the bottom of filtration element 1 through housing inlet 6, concentrate being taken from the top of filtration element through outlet 5, and filtrate being withdrawn through outlet 4 in housing 2, preferably at or near the top thereof as shown in FIG. 1. If desired, filtration element 1 can be inverted such that housing inlet 6 is at top and outlet 5 at or near the bottom of housing 2, to create a generally downward direction of flow through filtration element 1. Inlets for feed fluid may be provided at both the top and bottom ends of filtration element 1, as described more fully below.

When present, inlet end cap 7 is directly or indirectly affixed to housing 2, preferably being affixed directly and sealed around housing inlet 6 of housing 2, via welding, gluing, gasketing, various mechanical means, and/or other methods that create a seal. Similarly, inlet end cap 7 is in fluid communication with housing inlet 6 of the housing 2, whether the inlet end cap 7 and the housing inlet 6 are affixed directly or indirectly. In this context, two components that are affixed indirectly may be joined via a length of pipe, for example, or by another connector that is known in the art. Inlet end cap 7 has opening 8 for receiving feed fluid from an external feed source (not shown). Inlet end cap 7 defines a flow path for the feed fluid from opening 8 of inlet end cap 7 through opening 21 of inlet end cap 7 and into housing inlet 6 of housing 2. Referring to FIGS. 2 and 3, arrows 19 indicate the direction of flow of feed fluid through housing inlet 6 in housing 2 in this particular embodiment.

A preferred inlet end cap 7 is a T-piece as shown in FIGS. 1-3. T-piece 7 includes hollow body 23 which defines a branched internal flow path for feed fluid to flow from opening 8 to both outflow 18 and opening 21. Opening 21 is in fluid communication with housing inlet 6 of housing 2. Opening 21 in the embodiment shown is fitted with filter 11, which is in the flow path of feed fluid entering housing inlet 6 in housing 2. Although not depicted, it is contemplated that filter 11 may alternatively be placed within or upstream of opening 8 with equally beneficial effect. During operation, at least a portion of feed fluid flows out of T-piece 7 through opening 21 into housing inlet 6 of housing 2 of filtration element 1. A portion of feed fluid entering opening 8 of T-piece 7 may in addition flow through T-piece 7 and out of T-piece 7 through outflow 18, from which it may flow, for example, into a corresponding T-piece 7 of an adjacent filtration element 1 (as shown in FIG. 5). In such embodiments, the filter 11 may be located downstream of the T-piece 7, in outlet 18, for example, or in a connection between outlet 18 and opening 8 of adjacent filter elements 1.

Filter 11 is preferably positioned within housing inlet 6 or (as shown in FIGS. 2 and 3) within inlet end cap 7 and within the flow path of the feed fluid to housing inlet 6 in housing 2. The orientation shown in FIGS. 2 and 3 is a preferred one in which filter 11 is oriented transverse to the direction of flow of feed fluid through housing inlet 6 of housing 2. Filter 11 may alternatively be oriented at an angle to the direction of flow of feed fluid through housing inlet 6, provided that feed fluid entering housing inlet 6 passes through filter 11.

Filtration element 1 further includes at least one outlet for removing filtrate from filtration element 1 and may include a separate outlet for removing concentrate. In the particular embodiment shown in FIGS. 1-3, separate outlets 4 and 5 are provided. Depending on the mode of operation (outside-in or inside-out), outlets 4 and 5 each may be either a filtrate or concentrate removal outlet, provided one is a filtrate removal outlet and one is a concentrate removal outlet. Outlet 4 is preferably a filtrate removal outlet and outlet 5 is preferably a concentrate removal outlet.

In the particular embodiment shown in FIG. 1, outlet 5 is positioned on optional second end cap 9, which is affixed to housing 2 and provides a flow path from a top opening of housing 2 to outlet 5 of end cap 9, from which filtrate or concentrate, preferably concentrate, is removed from interior volume 20 of housing 2. Second end cap 9 preferably is sealed around the top opening of housing 2 in the same manner as described with regard to inlet end cap 7, via welding, gluing, gasketing, various mechanical means, and the like. Similarly, outlet 4 may be positioned on an optional outlet end cap 9.

A preferred outlet end cap 9 is a T-piece (as shown in FIGS. 1, 4 and 5) that includes a hollow body which defines a branched internal conduit having outlet 5, an inlet for receiving filtrate or concentrate from opening of housing 2, and a second inlet 15, opposite outlet 5, for receiving fluid from a T-piece outlet end cap 9 of an adjacent filtration element 1 or other source. The branched internal conduit defines a flow path from the top opening of housing 2 to both outlet 5 and the second inlet 15. During operation, filtrate or concentrate, as the case may be, exiting interior volume 20 of housing 2 through the top opening in housing 2 flows through the T-piece outlet end cap 9 and out of T-piece outlet end cap 9 through outlet 5, from which it may flow, for example, into the second inlet 15 of a corresponding T-piece outlet end cap 9 of an adjacent filtration element 1 (as shown in FIG. 5).

Filter 11 preferably has a nominal opening size of 5 to 500 μm (mesh number about 35 openings/lineal inch or greater). The “nominal” opening or aperture size is that reported by the filter manufacturer. To avoid creating an unnecessarily large pressure drop while still removing particles of the sizes most frequently encountered, the nominal opening size of filter 11 is preferably 50 to 300 μm (mesh number about 270 to about 50), especially 88 to 300 μm (mesh number about 170 to about 50). Filter 11 is preferably a screen, especially a mesh screen, the material of construction of which can vary widely provided the screen is dimensionally stable in the feed fluid and under the pressure conditions encountered during operation. Metal meshes and hydrophobic organic or inorganic polymer mesh screens are particularly suitable.

The surface area of filter 11 preferably is at least 40%, at least 60%, at least 75% or at least 80%, and up to 100% or more, of the surface area of housing inlet 6 of housing 2, to minimize pressure drop across filter 11. Filter 11 may comprise a screen affixed to a frame or other support. For purposes of determining surface area, the surface area of any frame or support is not counted towards the filter surface area.

Again, when more than one filter 11 is present in the filtration element 1 or in the filtration system 100, the material from which they are fabricated, their nominal opening sizes, and their surface areas are independent and may be the same or different. Moreover, the filters 11 may be located in one or more of the positions described herein as suitable.

The embodiment shown in FIG. 2 includes a preferred feature, a filter mount 12, which is adapted to receive and secure filter 11 in place. In the embodiment shown in FIG. 2, filter mount 12 is a mounting ring, which is secured to inlet end cap 7, in a preferred position within opening 21. In this position, filter 11 when mounted onto filter mount 12 is oriented transversely to the direction of flow of feed fluid through housing inlet 6 of housing 2.

Alternatively, filter mount 12 and/or filter 11 may be positioned within housing inlet 6 of housing 2, again preferably oriented transversely to the direction of flow of feed fluid through housing inlet 6 of the housing 2. It is also within the scope of the preferred embodiments to position filter mount 12 and/or filter 11 elsewhere within end cap 7, such as within opening 8 of end cap 7, provided filter 11 is positioned upstream of housing inlet 6 of housing 2.

Filter mount 12 may be secured in place on inlet end cap 7 and/or within opening 6 of housing 2 by any suitable means including via an adhesive, welding, via a mechanical connector (such as a screw mount or bayonet mount), and may alternatively be formed integrally with inlet end cap 7 or housing 2, as the case may be.

Filter 11 most preferably is removably mounted onto filter mount 12 or other mount (if used) or directly onto housing 2 of filtration element 1 or inlet end cap 7. Preferably, filter 11 and the structure to which it is affixed (i.e., a mount such as filter mount 12, housing 2 or inlet end cap 7) preferably have reciprocal apparatus for mounting and securing filter 11 in place. There may be provided, for example, reciprocal apparatus that together form a bayonet mount, a screw mount, a snap or friction mount, a magnetic mount, or other convenient apparatus for mounting and securing filter 11 in place.

Another filter mount 12 and/or filter 11 may be secured within end cap 9 or an associated opening in housing 2 in analogous manner, if feed fluid is to be introduced into filtration element 1 from that direction.

Each microfiltration or ultrafiltration membrane 3 may be, for example, a spiral wound or especially a hollow fiber membrane, with the latter being particularly preferred. Hollow fiber membranes may each have multiple capillaries to increase effective surface area. Hollow fiber membranes typically are potted at each end to secure them within interior volume 20 of housing 2. Multiple hollow fiber membranes are typically provided, the total number of which may be, for example, 10 to 10,000 or more. Active membrane area may be, for example 10 to 250 m². Multiple hollow fiber membranes are generally separated from each other to allow fluid (feed fluid or filtrate, as the case may be) to flow between the hollow fibers. The term “vertically-oriented”, when used herein in reference to hollow-fiber membranes, means that the length of the hollow fibers is disposed parallel to the central axis of a cylindrical housing. Suitable microfiltration and ultrafiltration membranes and configurations of the membranes for use within a housing such as housing 2 are described in PCT Intl. Appln. Publn. No. WO2020/094463 by Heijnen and Staaks, for example.

The filtration assembly 100 and the filtration system 101 described herein may be operated in a similar manner to conventional filtration elements that lack filter 11. In one mode of operation, feed fluid is introduced under pressure into opening 8 of inlet end cap 7, through filter 11 and housing inlet 6 of housing 2 and into interior volume 20. Within interior volume 20, a portion of feed fluid passes through one or more microporous or ultrafiltration membranes 3, thereby being separated into filtrate (or reject) and concentrate. In the specific embodiment shown in FIGS. 1-3, the filtrate and concentrate are separately removed from filtration element 1 via outlets 4 and 5, respectively.

In another embodiment and corresponding mode of operation, filtration assembly 100 is adapted to receive feed flow from both ends of filtration element 1, i.e., through housing inlet 6 and through a top opening at the opposing end of housing 2 (which in such an embodiment functions as a second housing inlet 6). In such an embodiment, feed fluid introduced through housing inlet 6 and the opposing opening dead-head within filtration element 1. A portion of the feed fluid permeates microfiltration or ultrafiltration membrane 3 to produce a filtrate that is removed via a filtrate outlet such as outlet 4. Reject in such embodiments is typically retained within microfiltration or ultrafiltration membrane 3. Reject is removed periodically by backwashing or otherwise flushing reject from microfiltration or ultrafiltration membrane 3, typically removing the reject via either or both of housing inlet 6 and the top opening of housing 2. In such embodiments, a filter such as filter 11 preferably is associated with the top opening of housing 2 in the same manner as described with regard to filter 11 associated with housing inlet 6. As before, such a filter is positioned within such opening or within an associated inlet end cap (such as end cap 9 in FIG. 1) and within the flow path of the feed fluid from an inlet opening in end cap 9 to the associated opening in housing 2. End cap 9 in such a case is as generally described with regard to inlet end cap 7, and is preferably a T-piece as described with regard to inlet end cap 7.

The suitable features of the filter(s) 11 when associated with the top opening of housing 2 are as described above with respect to the filter(s) 11 associated with the housing inlet 6. The materials, placement, and configuration of the filter(s) at the top opening and at the inlet may correspond in some manner, as, for example, in mirror-image symmetry. The features of the filters 11 at the housing inlet 6 and at the top opening of the filter element 1 are independent of each other, however, and may be the same or different.

The filtration element 100 described herein may be operated in either an inside-outside mode of operation, or an outside-inside mode of operation.

In an inside-outside mode of operation, feed fluid is fed into the capillaries of the hollow fiber membranes 3 and filtrate passes through the membranes and into open spaces between the membranes 3 within interior volume 20 of housing 2. With regard to the particular embodiment shown in FIGS. 1-3, filtrate in such a case is removed via outlet 4, and concentrate removed via outlet 5. In an outside-inside mode of operation, feed fluid is fed into open spaces in interior volume 20 between the hollow fiber membranes 3, and filtrate passes through the membranes into the capillaries. In such a case, concentrate is removed via outlet 4 and filtrate is removed via outlet 5.

Conduits for collected filtrate and concentrate typically are provided and are in fluid communication with the corresponding outlet in filtration element 1 for recovering filtrate and concentrate for use, disposal and/or further treatment (such as by nanofiltration or reverse osmosis). As mentioned before, some or all of such conduits can be formed by connected T-pieces of adjacent filtration elements as shown in FIG. 5.

Due to the presence of the filter 11 within the filtration assembly 100, it is often unnecessary to treat the incoming feed fluid in an upstream filtration step, such as by passing it through a separate, upstream filtering apparatus. Accordingly, such upstream filtering apparatus often can be omitted, which represents a substantial savings in both capital and operating costs.

Cleaning is conveniently performed by passing one or more backwashing fluids through filtration assembly 100 in the opposite direction, i.e., by being introduced into filtration element 1 via either or both of outlets 4 and 5 and being removed therefrom through housing inlet 6 of housing 2. The backwashing fluid passes into inlet end cap 7 from housing inlet 6 of housing 2, passes through filter 11 and is removed from inlet end cap 7 via an opening therein such as opening 8 or outflow 18.

A significant and surprising advantage of the filtration assemblies described herein is that much or all of the scale, entrapped solids and other debris removed from the membrane surfaces during the cleaning process passes easily through filter 11 and can be removed readily from filtration element 1 despite the presence of the filter. Loosely agglomerated material tends to break apart during the cleaning processes and little if any is retained on the filter. Thus, it is mostly unnecessary to remove the filter 11 from filtration element 1 prior to backwashing, although it is within the scope of the processes described herein to do so, particularly in preferred processes in which the filter 11 is removable. It may be beneficial to perform periodic cleaning/backwashing operations with the filter in place within filtration element 1, and to perform less frequent cleaning/backwashing operations with the filter removed, to ensure complete removal of solids that do not pass through the filter. Cleaning and/or backwashing may include a chemical cleaning step.

In embodiments in which inlet end cap 7 and end cap 9 each are T-pieces (as shown in FIGS. 1 and 5), the filtration element 100 is suitable for use in a multi-element filtration system such as described in European Pat. No. EP 1 743 690B1. Such a multi-element filtration system is characterized in having multiple filtration elements arranged in a row, the top and bottom T-pieces end caps of each element being directly or indirectly joined with a T-piece end cap of an adjacent filtration element to form a liquid conduit. Similarly, in the arrays provided herein, T-piece inlet end caps 7 of adjacent filtration assemblies 100 are joined to produce a feed fluid feed pipe which provide feed fluid to each filtration element in a row. Likewise, T-piece outlet end caps 9 of adjacent filtration elements are joined to produce a collection pipe for collecting filtrate or concentrate from each filtration element 1 in the row.

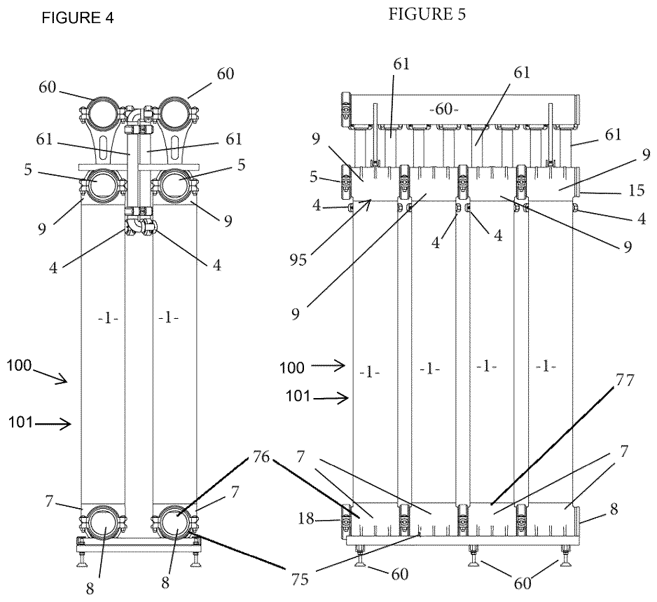

Turning to FIGS. 4 and 5, there is shown an embodiment of such a multi-element filtration system 101, in this case having two rows of filtration assemblies 100 comprising filtration elements 1. Inlet end caps 7 of filtration elements 1 in each row are joined to produce feed fluid pipe 75. T-piece outlet end caps 9 of filtration elements 1 in each row are joined to produce concentrate collection pipes 95. Outlets 4 of filtration elements 1 are in fluid communication with filtrate discharge pipes 60 via connectors 61. As shown, aligned filtration elements 1 from each row each feed into a single filtrate discharge pipe 60; however, each filtration element in the row may if desired feed into a separate discharge pipe. Filtrate discharge pipes 60 as shown are in a preferred position above concentrate collection pipes 95. Such a system is described in more detail in European Pat. No. EP 1 743 690 B1.

In another preferred embodiment, the filtration system 101 described herein comprises:
a plurality of optionally cyclindrical filtration elements 1 arranged in parallel, each of said filtration elements 1 comprising:
   a housing 2 that encloses an interior volume 20;
   a plurality of membranes 3 located within the interior volume 20; said membranes 3 selected from the group consisting of microfiltration, ultrafiltration, nanofiltration, and reverse osmosis membranes; and said membranes 3 dividing the interior volume 20 into a feed region and a filtrate region;
   a housing inlet 6 for introducing a feed fluid into the feed region of the filtration element 1; and
   a housing outlet 4 for removing filtrate from the filtrate region of the filtration element 1; and
a manifold having a distribution conduit and a plurality of manifold outlets; or, alternatively, a feed fluid pipe 75 and a plurality of fluid connections between the feed fluid pipe 75 and the filter elements 11;
wherein each of said plurality of filtration elements 1 is associated with a specific manifold outlet or fluid connection, such that said plurality of membranes 3 within the filtration element 1 receive feed fluid from said specific manifold outlet or fluid connection; and at least one filter 11 is located along a feed flow pathway between the membranes 3 within the housing 2 of a filtration element 1 and the associated manifold outlet.

Referring to FIGS. 4 and 5, the filtration assembly 100 preferably includes a distributor 75 and a plurality of filtration elements 1. In more preferred embodiments, each filtration element 1 is associated with a specific distributor outlet region 77, such that the membranes 3 within that filtration element 1 receive feed fluid from that specific distributor outlet region 77.

A distributor 75 comprises a feed fluid pipe 76 and a plurality of distributor outlet regions 77. The distributor itself 75 may be a single unit or an assembly. As illustrated in FIG. 5, the feed fluid pipe 76 is preferably a co-linear region suitable to convey a common feed to multiple different filtration elements 1. Preferably, the multiple different filtration elements 1 arranged in parallel within the filtration assembly 100. The common feed within the feed fluid pipe 75 is preferably supplied from a common operation (e.g. from a pump or pre-filter that serves more than one filtration element 1). The feed fluid pipe 76 is in fluid communication with a plurality of distributor outlet regions 77. Each distributor outlet region 77 is a region separate from the feed fluid pipe 76, and the distributor outlet region 77 is defined by an event horizon or transition in the fluid flow, wherein the feed fluid passing through the distributor outlet region 77 is associated with a single filtration element 1.

At least one filter 11 is located along a feed flow pathway between the membranes 3 within the housing 2 of a filtration element 1 and the associated distributor outlet region 77. In FIGS. 4 and 5, the distributor 75 is illustrated as an assembly of connected inlet end caps 7 that together form a continuous and linear feed fluid pipe 76. In this embodiment, each inlet end cap 7 includes a distributor outlet region 77, just upstream of the filter 11. In other embodiments, the filter 11 may be located further downstream, including outside of the inlet end cap 7.

Each filtration element 1 within the filtration assembly 100 is preferably associated with a specific distributor outlet region 77 and at least one associated filter 11. The apertures of the filter(s) preferably have a nominal size ranging from 5 to 500 μm. The filters 11 are located along a feed flow pathway between the membranes 3 within the housing 2 of that filtration element 1 and the associated distributor outlet region. Feed fluid passing through the associated the associated filter 11 is destined for (and associated with) a specific associated element 1. Hence, each associated filter 11 is at or downstream of the event horizon that defines the distributor outlet region 77.

While not illustrated in FIGS. 4 and 5, one skilled in the art will easily apprehend how a plurality of membranes 3 located within the interior volume 20 will divide the interior volume 20 into a feed region and a filtrate region. For instance, the lumen of a hollow fiber and the exterior of the same hollow fiber would each correspond to two different regions within the interior volume, these two regions being the feed region and a filtrate region.

Further, in this apparatus, preferably each filtration element 1 is associated with at least one filter 11, and said at least one filter 11 is located along a feed flow pathway between the membranes 3 within the housing 2 of that filtration element 1 and an associated manifold outlet. Preferably, the nominal size of the apertures in the filter 11 ranges from 5 to 500 μm. The membranes 3 are selected independently, that is, the filtration element 1 may include a plurality of one type of membrane 3, or any combination of two or more types of membrane 3.

The multi-element filtration apparatus described herein is useful for filtering a wide variety of fluids, especially aqueous fluids such as groundwater, surface water, seawater, process streams from chemical operations and/or power generating stations, as well as many others. In a particular embodiment, the multi-element filtration apparatus is a seawater ultrafiltration and/or microfiltration apparatus, and can be used, for example, as a prefilter for preparing seawater for reverse osmosis to produce potable water.

The following example is provided to describe the invention in further detail. This example, which sets forth specific embodiments and a preferred mode presently contemplated for carrying out the invention, is intended to illustrate and not to limit the invention.

### EXAMPLE

A filtration element as shown in FIGS. 1-3 is installed in a pilot-scale filtration apparatus. Unfiltered feed water is fed into filtration element 1 through opening 8 of T-piece 7, from which it flows through body 23 of T-piece 7 and filter 11 before entering housing 2 via housing inlet 6. The filtration element contains hollow fiber membranes 3 operated in an inside-outside manner to produce a filtrate that is removed via outlet 4 and a permeate that enters T-piece 9 and is removed.

Pressure is measured immediately above and below filter 11 to determine pressure drop across the filter. During 80 days of continuous operation, the pressure drop remains consistently at 0.02 bar (2 KPa) with no pressure excursions exceeding 0.1 bar (10 KPa). Filtered water quality is not materially different than a base case wherein a like filtration element not containing filter 11 is fed pre-filtered feed water.

During operation, solid matter passing through filter 11 accumulates to form agglomerates within filtration element 1, particularly within the hollow fiber membranes 3. Upon backwashing, the agglomerates break up and pass easily back through the filter 11. Periodic chemical cleaning cleans both the membranes 3 and the filter 11.

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A filtration assembly 100 comprising
a) a housing 2 enclosing an interior volume 20 of the filtration assembly 100; said housing 2 optionally comprised by a filtration element 1;
b) at least one microfiltration or ultrafiltration membrane 3 disposed within the interior volume 20 of the housing;
c) at least one outlet 4 for removing filtrate from the housing 2;
d) at least one housing inlet 6 in the housing 2 for introducing feed fluid into the housing 2;
e) for at least one housing inlet 6, an associated inlet end cap 7 affixed to the housing 2 and in fluid communication with the housing inlet 6 in the housing 2, the inlet end cap 7 having an opening 8 for receiving feed fluid and defining a flow path for the feed fluid from the opening 8 of the inlet end cap 7 to the associated housing inlet 6 of the housing 2, and
f) for at least one housing inlet 6 having an associated inlet end cap 7, an associated filter 11 positioned (i) within the housing inlet 6 or (ii) within the associated inlet end cap 7 and within the flow path of the feed fluid from the opening 8 of the inlet cap 7 to the associated housing inlet 6 in the housing 2.

2. A filtration assembly 100 comprising
a) a filtration element 1, said filtration element 1 comprising a housing 2 and said housing 2 enclosing an interior volume 20;
b) at least one microfiltration or ultrafiltration membrane disposed within the interior volume 20 of the housing 2;
c) at least one outlet 4 for removing filtrate from the filtration element 1;
d) at least one housing inlet 6 in the housing 2 for introducing feed fluid into the filtration element 1;
e) for at least one housing inlet 6, an associated inlet end cap 7 affixed to the housing 2 and in fluid communication with the housing inlet 6 in the housing 2, the inlet end cap 7 having an opening 8 for receiving feed fluid and defining a flow path for the feed fluid from the opening 8 of the inlet end cap 7 to the associated housing inlet 6 of the housing 2, and
the housing inlet 6 or (ii) within the flow path of the feed fluid to the associated housing inlet 6 in the housing 2.

3. The filtration assembly 100 of claim 1, wherein the filter 11 is oriented transversely to the direction of flow of feed fluid through the associated housing inlet 6; or wherein the filter 11 is a screen; or wherein the filter 11 comprises an aperture having a nominal size ranging from 5 to 500 μm; or wherein the filter 11 is removably mounted; or wherein the filter 11 has a surface area at least 40% of the surface area of the associated housing inlet 6 of the housing 2; or wherein the filter 11 comprises multiple smaller filter elements assembled to form the filter 11.

4. (canceled)

5. (canceled)

6. The filtration assembly 100 of claim 1, further comprising a filter mount 12 at the housing inlet 6 of the housing 2 or in the inlet end cap 7, and the filter 11 is mounted on the filter mount 12; and optionally wherein the filter mount 12 is a mounting ring.

7. (canceled)

9. (canceled)

10. The filtration assembly 100 of claim 1, wherein each inlet end cap 7 is a T-piece adapted to engage on each opposing side with a T-piece inlet end cap of an adjacent filtration element to produce an inflow conduit 75.

11. The filtration assembly 100 of claim 1, further comprising an outlet end cap 9 affixed to the housing 2 and in fluid communication with the interior volume 20 of the housing 2 and defining a flow path for concentrate and/or filtrate from the interior volume 20 of the filtration element to an outlet 5 of the outlet end cap 9; and optionally wherein the outlet end cap 9 is a T-piece adapted to engage on each opposing side with a T-piece outlet end cap of an adjacent filtration element to produce an outflow conduit 60.

12. (canceled)

13. The filtration assembly 100 of claim 1, wherein at least one housing inlet and the associated inlet end cap(s) 7 are at a bottom end of the housing 2; or wherein at least one housing inlet 6 and the associated inlet end cap(s) 7 are at a top end of the housing 2.

14. (canceled)

15. The filtration assembly 100 of claim 1, wherein a first housing inlet 6, a first end cap 7 and a first filter 11, said first end cap 7 and a first filter 11 associated with the first housing inlet 6, are at a top end of the housing 2; and wherein a second housing inlet 6, a second end cap 7 and a second filter 11, said second end cap 7 and said second filter 11 associated with the second housing inlet 6, are at a bottom end of the housing 2.

16. The filtration assembly 100 of any preceding claim 1, further comprising a concentrate outlet port 5 in the housing 2 for removing concentrate from the interior volume 20 of the filtration element 1.

17. The filtration assembly 100 of claim 1. wherein the microfiltration or ultrafiltration membrane 3 comprises multiple vertically-oriented hollow fibers.

18. A filtration system 101 comprising two or more filtration assemblies 100 of claim 1, wherein said filtration assemblies 100 are optionally arranged vertically in a row.

19. The filtration system 101 of claim 18 wherein the two or more filtration assemblies 100 are arranged vertically in a row, and wherein the inlet end caps 7 are T-pieces connected together to produce a feed fluid pipe 75.

20. The filtration system 101 of claim 19 wherein each filtration assembly 100 further comprises an outlet end cap 9 affixed to the housing 2; wherein said outlet end cap 9 is in fluid communication with the interior volume 20 of the housing 2 and defines a flow path for concentrate and/or filtrate from the interior volume 20 to an outlet of the outlet end cap 9, wherein each outlet end cap 9 is a T-piece adapted to engage on each opposing side with the outlet of the end cap 9 of the adjacent filtration assembly 100 in the row to produce an outflow conduit 60; and wherein the outlets of the outlet end caps 9 are connected together to produce a concentrate collection pipe 95.

21. The filtration system 101 of claim 20, wherein each of the filtration assemblies 100 further comprises a filtrate outlet port 4 in the housing 2 for removing filtrate from the interior volume 20, each filtrate outlet port 4 being in fluid communication with a filtrate collecting the outlet flow conduit 60; and wherein the outlet flow conduit 60 is optionally disposed above and parallel to the concentrate collection pipe 95.

22. A filtration assembly 100 for filtration of a feed fluid, said filtration assembly 100 comprising a plurality of filtration elements 1 arranged in parallel, each of said filtration elements 1 comprising:
a housing 2 that encloses an interior volume 20;
a plurality of membranes 3 located within the interior volume 20, said membranes 3 dividing the interior volume 20 into a feed region and a filtrate region;
a housing inlet 6 for introducing feed fluid into the feed region; and
a housing outlet 4 for removing filtrate from the filtrate region; and
a distributor 75 having a feed fluid pipe 76 and a plurality of distributor outlet regions 77;
such that said plurality of membranes 3 receives feed fluid from at least one of said distributor outlet regions 77; and wherein at least one filter 11 is located along a feed flow pathway between the plurality of membranes 3 and the at least one distributor outlet region 77.

23. The filtration assembly 100 of claim 22 wherein the filter(s) 11 comprise an aperture having a nominal size ranging from 5 to 500 μm; or wherein the membranes 3 are hollow fiber membranes.

24. A filtration system 101 comprising two or more of the filtration assemblies 100 of claim 22.

25. A filtration process comprising the steps of: introducing a feed fluid into a filtration system 101 comprising the filtration assembly 100 of claim 1 through the associated filter 11 and the housing inlet 6, passing at least a portion of the feed fluid through the microfiltration or ultrafiltration membrane 3 to produce a filtrate and a concentrate, and withdrawing at least a portion of the filtrate or of the concentrate from the filtration assembly 100.

26. A filtration process comprising the steps of: introducing a feed fluid into the filtration system 101 of claim 18 through the associated filter 11 and associated the housing inlet 6, passing at least a portion of the feed fluid through the microfiltration or ultrafiltration membrane 3 to produce a filtrate and a concentrate, and withdrawing at least a portion of the filtrate or of the concentrate from the filtration assembly 100.

27. The filtration process of claim 25 further comprising the step of introducing a backwashing fluid into the filtration assembly 100, wherein at least a portion of the backwashing fluid is directed into contact with the microfiltration or ultrafiltration membrane 3, and wherein the portion of the backwashing fluid is directed out of the filtration assembly 100 through the housing inlet 6, the associated filter 11 and the inlet end cap 7; and optionally wherein the backwashing step comprises a chemical cleaning step.

28. (canceled)
